(19) United States
(12) Patent Application Publication
(10) Pub. No.: US 2023/0328568 A1
(43) Pub. Date: Oct. 12, 2023

(54) QUANTIZATION SCHEME FOR CHANNEL STATE INFORMATION REPORTS

(71) Applicant: QUALCOMM Incorporated, San Diego, CA (US)

(72) Inventors: Liangming Wu, Beijing (CN); Chenxi Hao, Beijing (CN); Yu Zhang, San Diego, CA (US); Min Huang, Beijing (CN); Qiaoyu Li, Beijing (CN); Rui Hu, Beijing (CN); Kangqi Liu, San Diego, CA (US); Wei Xi, Beijing (CN); Hao Xu, Beijing (CN); Wanshi Chen, San Diego, CA (US)

(21) Appl. No.: 18/043,345

(22) PCT Filed: Sep. 11, 2020
(86) PCT No.: PCT/CN2020/114741

§ 371 Date: Feb. 28, 2023

(51) Int. Cl. H04W 24/10; H04W 24/08

(52) U.S. Cl. CPC H04W 24/10; H04W 24/08

(57) ABSTRACT

Aspects of the disclosure relate to the generation of channel state reports. A base station transmits a reference signal over a plurality of ports. A user equipment (UE) receives the reference signal and measure amplitudes of the reference signal over a plurality of ports. A first subgroup of the plurality of ports and a second subgroup of the plurality of ports are determined. In embodiments, the port groupings may be determined by the base station, which transmits an identification of the groupings to the user equipment. Alternatively, the UE may determine the port groupings. After determining the port groupings, the UE separately quantizes and normalizes the measured amplitude values in each port grouping. The UE may also separately quantize and normalize the phase measurements in each port groups. The UE generates a channel state report based on the normalized and quantized amplitude and phase values.

### TECHNICAL FIELD

The technology discussed below relates generally to wireless communication systems, and more particularly, to quantization approaches for channel state information reports in a wireless transmission.

### INTRODUCTION

In wireless communication systems, the use of multiple antennas at a transmitter and/or at a receiver can provide improved functionality beyond the use of a single antenna at each endpoint. For example, beamforming, or the directional transmission or reception of a wireless signal, can be achieved by applying a suitable precoding matrix to a signal transmission. That is, the amplitude and phase of each antenna in an array of antennas may be precoded, or controlled to create a desired (e.g., directional) pattern of constructive and destructive interference in the wavefront. In another example, sometimes referred to as spatial multiplexing or multiple-input multiple-output (MIMO), a transmitter can transmit multiple different streams of data, also referred to as layers, simultaneously on the same wireless resources. Similar to beamforming, for MIMO, the transmitter applies a suitable beamforming matrix to a signal transmission.

For beamforming and for MIMO, generation of a suitable precoding matrix generally corresponds to sophisticated processing of a timely channel estimate, where a reference signal transmitted over the channel is received and measured. The measurements are incorporated into a channel state report that is transmitted in reply to the reference signal. To reduce the data size of the channel state report, data contained within the report may be quantized into discrete values. As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some examples, a method, apparatus, and computer-readable medium for generating a channel estimate are disclosed. A reference signal is received by a user equipment (UE) from a base station over a plurality of ports. The UE measures amplitudes of the reference signal over a first plurality of frequency domain (FD) basis components of a first port in the plurality of ports. A first amplitude of the reference signal over a first FD basis component of the first plurality of FD basis components is multiplied by a second amplitude of the reference signal over a second FD basis component of the first plurality of FD basis components by the UE to generate a modified amplitude. The UE associates the modified amplitude with the second FD basis component in a channel state report and transmits the channel state report to the base station.

In other examples, a method, apparatus, and computer-readable medium for generating a channel estimate are disclosed. A reference signal is received from a base station over a plurality of ports. A UE measures amplitudes of the reference signal over a plurality of ports and determines a first subgroup of the plurality of ports and a second subgroup of the plurality of ports. The UE determines a first amplitude of the reference signal for a first port in the first subgroup that is a highest amplitude of all amplitudes for ports of the plurality of ports in the first subgroup and associates a normalized amplitude value with the first port in a channel state report.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While the following description may discuss various advantages and features relative to certain embodiments and figures, all embodiments can include one or more of the advantageous features discussed herein. In other words, while this description may discuss one or more embodiments as having certain advantageous features, one or more of such features may also be used in accordance with the various embodiments discussed herein. In similar fashion, while this description may discuss exemplary embodiments as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an organization of wireless resources in an air interface utilizing orthogonal frequency divisional multiplexing (OFDM) according to some embodiments.

FIG. 4 is a block diagram illustrating a wireless communication system supporting multiple-input multiple-output (MIMO) communication.

FIG. 5A is a diagram depicting the general structure of a sample codebook.

FIGS. 5B and 5C are schematic illustrations of a base station-generated portion of a precoder according to some examples.

FIGS. 6A and 6B are schematic illustrations of a base station-generated portion of a precoder according to further examples.

FIG. 7A is a flow chart illustrating an exemplary process for a UE to process channel measurement data for generation of a CSI report using port polarization data.

FIG. 7B shows a data array depicting channel state measurements quantized and normalized by a UE according to the method depicted in FIG. 7A.

FIG. 8A is a flow chart illustrating an exemplary process for a UE to quantize channel measurement according to port groupings.

FIG. 8B shows a data array depicting channel state measurements quantized and normalized by a UE according to the method depicted in FIG. 8A

FIG. 9A is a flow chart illustrating an alternate process for a UE to quantize channel measurements.

FIG. 9B shows a data array depicting channel state measurements quantized and normalized by a UE according to the method depicted in FIG. 9A.

FIG. 10A is a flow chart illustrating an alternate process for a UE to quantize channel measurements.

FIG. 10B shows a data array depicting channel state measurements quantized and normalized by a UE according to the method depicted in FIG. 10A.

FIG. 11 is a block diagram conceptually illustrating an example of a hardware implementation for a scheduling entity according to some aspects of the disclosure.

FIG. 12 is a block diagram conceptually illustrating an example of a hardware implementation for a scheduled entity according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

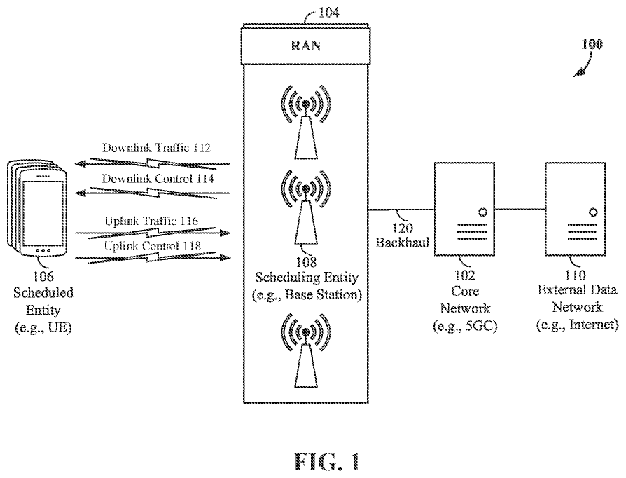

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 supports wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

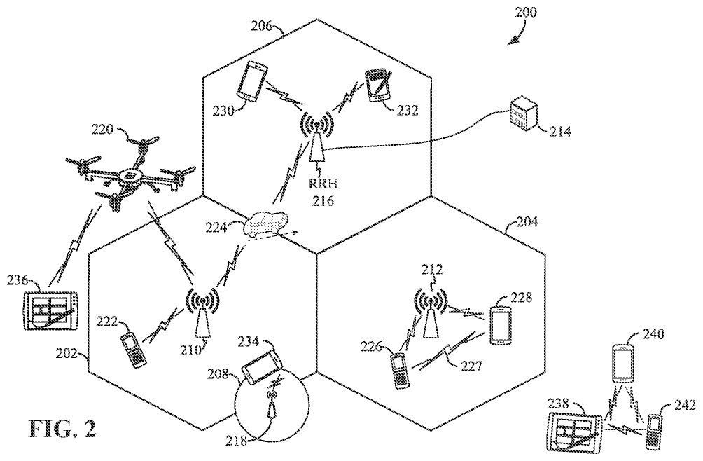

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

The air interface in the radio access network 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes. For example, a UE may provide for UL multiple access utilizing time division multiple access (TDMA), code division multiple access (CDMA), frequency division multiple access (FDMA), sparse code multiple access (SCMA), resource spread multiple access (RSMA), or other suitable multiple access schemes. Further, a base station 210 may multiplex DL transmissions to UEs 222 and 224 utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

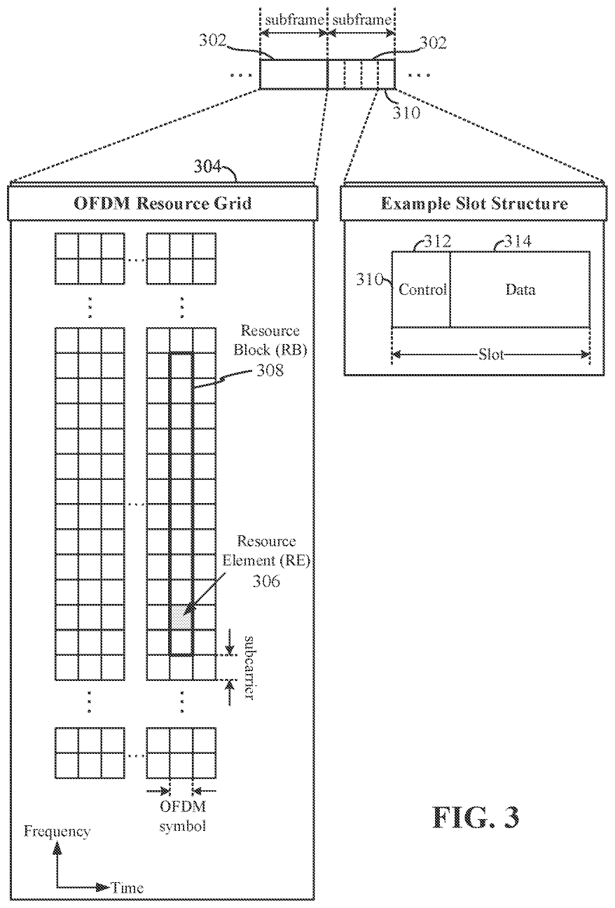

Various aspects of the present disclosure will be described with reference to an OFDM waveform, schematically illustrated in FIG. 3. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may consist of a set of subframes (e.g., 10 subframes of 1 ms each). On a given carrier, there may be one set of frames in the UL, and another set of frames in the DL. Referring now to FIG. 3, an expanded view of an exemplary DL subframe 302 is illustrated, showing an OFDM resource grid 304. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 304 may be used to schematically represent time-frequency resources for a given antenna port. That is, in a MIMO implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A UE generally utilizes only a subset of the resource grid 304. An RB may be the smallest unit of resources that can be allocated to a UE. Thus, the more RBs scheduled for a UE, and the higher the modulation scheme chosen for the air interface, the higher the data rate for the UE.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each subframe 302 (e.g., a 1 ms subframe) may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

An expanded view of one of the slots 310 illustrates the slot 310 including a control region 312 and a data region 314. In general, the control region 312 may carry control channels (e.g., PDCCH), and the data region 314 may carry data channels (e.g., PDSCH or PUSCH). Of course, a slot may contain all DL, all UL, or at least one DL portion and at least one UL portion. The simple structure illustrated in FIG. 3 is merely exemplary in nature, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In a DL transmission, the transmitting device (e.g., the scheduling entity 108) may allocate one or more REs 306 (e.g., within a control region 312) to carry DL control information 114 including one or more DL control channels that generally carry information originating from higher layers, such as a physical broadcast channel (PBCH), a physical downlink control channel (PDCCH), etc., to one or more scheduled entities 106. In addition, DL REs may be allocated to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The synchronization signals PSS and SSS (collectively referred to as SS), and in some examples, the PBCH, may be transmitted in an SS block that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106) may utilize one or more REs 306 to carry UL control information 118 (UCI). The UCI can originate from higher layers via one or more UL control channels, such as a physical uplink control channel (PUCCH), a physical random access channel (PRACH), etc., to the scheduling entity 108. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In addition to control information, one or more REs 306 (e.g., within the data region 314) may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. This system information may be provided utilizing minimum system information (MSI), and other system information (OSI). The MSI may be periodically broadcast over the cell to provide the most basic information a UE requires for initial cell access, and for acquiring any OSI that may be broadcast periodically or sent on-demand. In some examples, a network may provide MSI over two different downlink channels. For example, the PBCH may carry a master information block (MIB), and the PDSCH may carry a system information block type 1 (SIB1). Here, the MIB may include a UE with parameters for monitoring a control resource set. The control resource set may thereby provide the UE with scheduling information corresponding to the PDSCH, e.g., a resource location of SIB1. In the art, SIB1 may be referred to as remaining minimum system information (RMSI).

OSI may include any SI that is not broadcast in the MSI. In some examples, the PDSCH may carry a plurality of SIBs, not limited to SIB1, discussed above. Here, the OSI may be provided in these SIBs, e.g., SIB2 and above.

The channels or carriers described above and illustrated in FIGS. 1 and 3 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

In some examples, a physical layer may generally multiplex and map these physical channels described above to transport channels for handling at a medium access control (MAC) layer entity. Transport channels carry blocks of information called transport blocks (TB). The transport block size (TBS), which may correspond to a number of bits of information, may be a controlled parameter, based on the modulation and coding scheme (MCS) and the number of RBs in a given transmission.

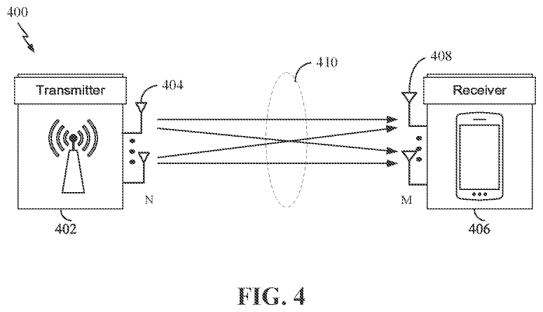

In some aspects of the disclosure, the scheduling entity and/or scheduled entity may be configured with multiple antennas for beamforming and/or multiple-input multiple-output (MIMO) technology. FIG. 4 illustrates an example of a wireless communication system 400 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, the amplitude and phase of each antenna in an array of antennas may be precoded, or controlled to create a desired (e.g., directional) pattern of constructive and destructive interference in the wavefront. In a MIMO system, a transmitter 402 includes multiple transmit antennas 404 (e.g., N transmit antennas) and a receiver 406 includes multiple receive antennas 408 (e.g., M receive antennas). Thus, there are N×M signal paths 410 from the transmit antennas 404 to the receive antennas 408. Each of the transmitter 402 and the receiver 406 may be implemented, for example, within a scheduling entity 108, a scheduled entity 106, or any other suitable wireless communication device.

In a MIMO system, spatial multiplexing may be used to transmit multiple different streams of data, also referred to as layers, simultaneously on the same time-frequency resource. In some examples, a transmitter may send multiple data streams to a single receiver. In this way, a MIMO system takes advantage of capacity gains and/or increased data rates associated with using multiple antennas in rich scattering environments where channel variations can be tracked. Here, the receiver may track these channel variations and provide corresponding feedback to the transmitter. In the simplest case, as shown in FIG. 4, a rank-2 (i.e., including 2 data streams) spatial multiplexing transmission on a 2×2 MIMO antenna configuration will transmit two data streams via two transmit antennas 404. The signal from each transmit antenna 404 reaches each receive antenna 408 along a different signal path 410. The receiver 406 may then reconstruct the data streams using the received signals from each receive antenna 408.

In some examples, a transmitter may send multiple data streams to multiple receivers. This may be referred to as multi-user MIMO (MU-MIMO). In this way, a MU-MIMO system exploits multipath signal propagation to increase the overall network capacity by increasing throughput and spectral efficiency, and reducing the required transmission energy. This is achieved by spatially precoding (i.e., multiplying the data streams with different weighting and phase shifting) each data stream (in some examples, based on known channel state information) and then transmitting each spatially precoded stream through multiple transmit antennas to the receiving devices using the same allocated time-frequency resources. The receiver may transmit feedback including a quantized version of the channel so that the transmitter can schedule the receivers with good channel separation. The spatially precoded data streams arrive at the receivers with different spatial signatures, which enables the receiver(s) (in some examples, in combination with known channel state information) to separate these streams from one another and recover the data streams destined for that receiver. In the other direction, multiple transmitters can each transmit a spatially precoded data stream to a single receiver, which enables the receiver to identify the source of each spatially precoded data stream.

The number of data streams or layers in a MIMO or MU-MIMO (generally referred to as MIMO) system corresponds to the rank of the transmission. In general, the rank of a MIMO system is limited by the number of transmit or receive antennas 404 or 408, whichever is lower. In addition, the channel conditions at the receiving device, as well as other considerations, such as the available resources at the transmitting device, may also affect the transmission rank. For example, a base station in a cellular RAN may assign a rank (and therefore, a number of data streams) for a DL transmission to a particular UE based on a rank indicator (RI) the UE transmits to the base station. The UE may determine this RI based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI along with resource information (e.g., the available resources and amount of data to be scheduled for the UE) to assign a DL transmission rank to the UE.

The transmitting device determines the precoding of the transmitted data stream or streams based, e.g., on known channel state information of the channel on which the transmitting device transmits the data stream(s). For example, the transmitting device may transmit one or more suitable reference signals (e.g., a channel state information reference signal, or CSI-RS; and/or a sounding reference signal, or SRS) that the receiving device may measure. In some cases, the receiver may then report measured channel quality information (CQI) back to the transmitting device. This CQI generally reports the current communication channel quality, and in some examples, a requested transport block size (TBS) for future transmissions to the receiver. In some examples, the receiver may further report a precoding matrix indicator (PMI) back to the transmitting device. This PMI generally reports the receiving device's preferred precoding matrix for the transmitting device to use, and may be indexed to a predefined codebook. The transmitting device may then utilize this CQI/PMI to determine a suitable precoding matrix for transmissions to the receiver.

In Time Division Duplex (TDD) systems, the UL and DL may be reciprocal, in that each uses different time slots of the same frequency bandwidth. Therefore, in TDD systems, a base station may assign a rank for DL MIMO transmissions based on measurement of an UL transmission (e.g., based on a sounding reference signal (SRS) or other pilot signal transmitted from the UE). Based on the assigned rank, the base station may then transmit a channel state information reference signal (CSI-RS) with separate precoding for each layer to provide for multi-layer channel estimation. From the CSI-RS, the UE may measure the channel quality across layers and resource blocks. The UE may then transmit a CSI report (including, e.g., CQI, RI, and PMI) to the base station for use in updating the rank and assigning resources for future downlink transmissions.

The channel quality information indicated in reports provided by the UE (e.g., SINR measurements, CSI reports, etc.), can enable the base station to select or optimize a precoder for transmissions to the UE in view of existing channel conditions. Because channel conditions may change over time, the base station may periodically transmit CSI-RSs to the UE (either at fixed intervals or in response to a request from the UE or other system component) in order to receive an updated CSI report in response to which the base station can further update the precoder used for transmissions to the UE. Each time a CSI-RS is transmitted to the UE, the base stations applies the current precoder to the CSI-RS being transmitted.

To illustrate, according to release-16 of 3GPP specifications for 5G NR, a base station may employ a certain Type II precoder to a CSI-RS transmission on a subband designated subband n. For example, a release-16 Type II precoder for subband n may be described according to the following equation.

$${\sum }_{i = 0}^{2 L - 1} {\sum }_{m = 0}^{M - 1} {b}_{i} \cdot {c}_{i m} \cdot {f}_{m}^{H} [ n ]$$

Here, bᵢ represents a spatial domain basis vector, or the spatial domain portion of a precoder. For example, b may correspond to the i-th column of a spatial domain basis W₁; L represents a number of spatial domain basis vectors in the spatial domain basis W₁. In various examples, the spatial domain basis W₁ may represent a singular-value decomposition (SVD) of the channel or carrier, based on a measurement of one or more suitable reference signals such as the SRS. However, within the scope of this disclosure a spatial domain basis W₁ may be a discrete Fourier transform (DFT) basis or any other suitable matrix that generally matches the spatial domain of the channel.

Further, fₘ^{H} represents a frequency domain basis vector. For example, fₘ^{H} may correspond to a row vector, e.g., being the m-th row of a frequency domain basis W_{F}^{H}. In various examples, W_{F}^{H} may represent a frequency domain basis of size M by N, where M is a number of frequency domain basis vectors, and N is a number of subbands (e.g., a number of columns in the frequency domain basis W_{F}^{H}). The superscript H represents a conjugate transform. While the discussion that follows assumes that the frequency domain basis vector fₘ^{H} is m-th row of W_{F}^{H}, within the scope of this disclosure, a frequency domain basis vector may generally correspond to a linear combination of a set of any suitable number of selected rows of W_{F}^{H}. In this example, fₘ^{H}[n] represents the element at the m-th row and n-th column of W_{F}^{H}.

Still further, om represents a set of linear combination coefficients corresponding to UE feedback based on UE beam measurements. For example, c_{i,m} may correspond to coefficient basis \tilde{W}_{2,l}. \tilde{W}_{2,l} may specify a particular set of coefficients to be measured by the UE after receiving the reference signal. Specifically, when a UE receives a reference signal (e.g., CSI-RS) over the precoded channel (e.g., over a plurality of ports), the UE can compare the different ports with one another (e.g., in terms of received signal power). Based on these channel measurements, the UE may rank and rate the different ports, and/or may select a subset of the ports that has a relatively strong power. Thus, the UE can provide feedback to the base station corresponding to the linear coefficients associated with the selected ports. Thus, the base station can utilize this linear coefficient information to update a precoder for a subsequent transmission.

With this release-16 type II precoder, the UE may provide the base station with feedback from which the base station can obtain the linear combination coefficients om and the frequency domain basis vector fₘ^{H}. Thus, according to the release-16 precoder, the base station calculates the spatial domain basis vector bᵢ (e.g., based on an UL reference signal from the UE), while the UE calculates the frequency domain basis vector fₘ^{H} (e.g., based on a DL reference signal from the base station). The base station then precodes a DL transmission based on this combination of information.

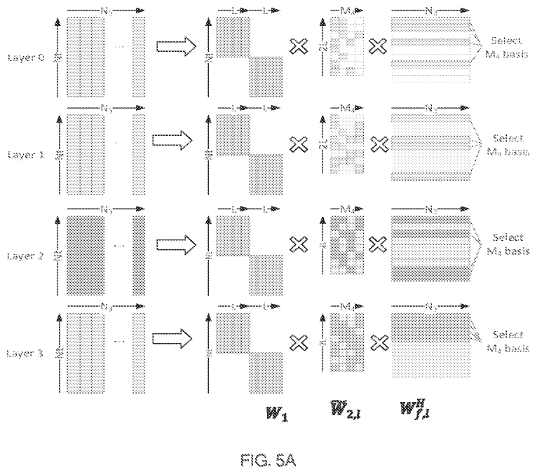

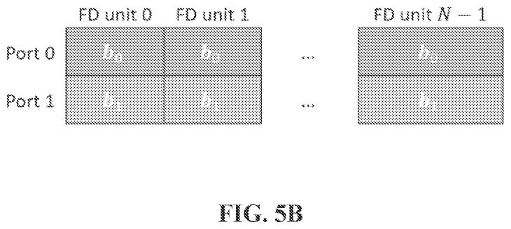

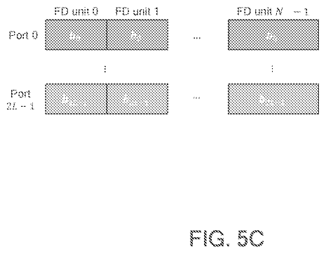

In a precoding scheme, the matrices W₁, \tilde{W}_{2,l}, and W_{F}^{H} are specified within a predetermined codebook. FIG. 5A is a diagram depicting the general structure of a sample codebook. As illustrated, the codebook specifies each of W₁, \tilde{W}_{2,l}, and W_{F}^{H} to be applied to a number of different input layers (e.g., streams of data). As described above, each W₁ basis for each layer establishes spatial domain vectors that, as described above, can be selected as part of a precoding scheme. In some implementations, the spatial domain basis W₁ may be the same across each layer defined within the codebook. In other cases, however, the codebook may specify different spatial domain basis W₁ for different layers within the codebook. The codebook also specifies a frequency domain basis W_{F}^{H} for each layer within the codebook. In the example shown in FIG. 5A, the frequency domain bases W_{F}^{H} are layer-specific and so may be different for each defined layer within the codebook. But in some cases, the frequency domain bases W_{F}^{H} may be the same for each layer within the codebook. The codebook also specifies the coefficient basis \tilde{W}_{2,l} for each layer within the codebook. As shown, the coefficient bases \tilde{W}_{2,l} can be different for each layer within the codebook. Though in alternative implementations, each layer may share the same coefficient basis \tilde{W}_{2,l}.

Referring now to FIG. 5B, this illustration is a grid that schematically shows one example of a base station-generated part of a release-16 Type II precoder, applied to two ports (Port 0 and Port 1) for transmission of a CSI-RS. In the illustrated table, each row shows a portion of a precoder the base station generates for a corresponding port, and each column n (where n=[0, . . . , N−1]) shows the precoder the base station generates for a corresponding FD unit (also referred to as an FD basis or FD basis component). In the discussion above, the notation n was discussed in relation to a particular FD basis called a ‘subband.’ In the discussion that follows, for generality, n will refer to an FD basis; and any reference to a subband may be inferred to be generalized to an FD basis.

The example depicted in FIG. 5B illustrates a base station-generated precoder for a specific sets of ports (in the example, two ports—Port 0 and Port 1). Alternatively, the base station may generate a precoder applicable to a larger number of ports, such as when implementing spatial domain (SD) and FD port emulation. In that case, the base station may be configured to provide a number of spatial linear beams and beamforming techniques may be utilized to generate a number of ports, where the number of ports is constrained by potential beam combinations.

Consequently, using such port emulation techniques, the base station may generate a precoder for up to 2 L−1 ports, where L is the number of spatial linear beams generated by the base station. In such an implementation, the ports may be arranged in order of magnitudes of polarization. For example, the precoder may be sorted according to increasing levels of polarization where the initial ports in the precoder (e.g., ports ranging from Port 0 to Port L−1) may exhibit reduced levels of polarization with respect to ports occurring later in the precoder (e.g., ports ranging from port L to port 2 L−1). Ports that exhibit greater levels of polarization may be characterized in that they are associated with higher power transmissions than ports exhibiting reduced levels of polarization.

To illustrate, FIG. 5C depicts a grid that schematically shows one example of a base station-generated part of a release-16 Type II precoder, applied to a number of ports determined by a number of available spatial linear beams. Specifically, the ports run from a first port 0 up to Port 2 L−1, where L is the total number of spatial linear beams. In the illustrated table, each row shows a portion of a precoder the base station generates for a corresponding port; and each column n (where n=[0, . . . , N−1]) shows the precoder the base station generates for a corresponding FD unit.

It has been observed that a base station can obtain better precoding performance if the base station, rather than the UE, generates the frequency-domain basis vector In this manner, the base station can consider frequency-selective characteristics of the channel in its determination of a precoder to employ. For example, a base station may freely generate a frequency domain basis vector based on, e.g., the SVD of the channel, a discrete cosine transform (DCT) basis, or any other kind of basis that matches the frequency domain of the channel. Thus, moving generation of the frequency-domain basis vector to the base station provides more flexibility in precoding, as well as alleviating the burden of calculating this parameter for the UE.

Accordingly, in the more recent release-17 of 3GPP specifications for 5G NR, when it employs a Type II precoder the base station generates the frequency-domain basis vector fₘ^{H}, as well as the spatial-domain basis vector bᵢ. In this example, the UE may provide the base station with feedback representing the linear combination coefficients c_{i,m}, omitting UE feedback corresponding to the frequency-domain basis vector fₘ^{H}. Here, while the release-17 Type II precoder can be expressed with the same equation as provided above for the release-16 Type II precoder, the parameters within that equation may have a different origin.

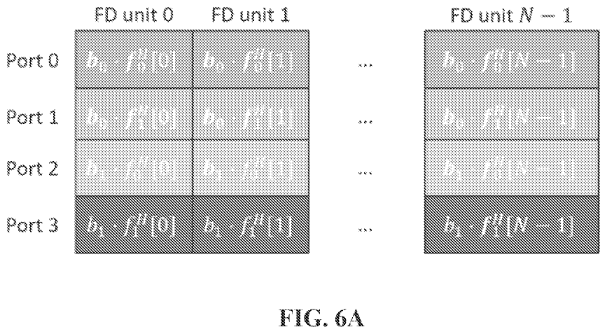

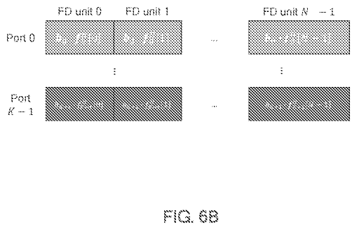

Referring now to FIG. 6A, this illustration is a grid that schematically shows one example of a base station-generated part of a release-17 Type II precoder, applied to four ports (Port 0, Port 1, Port 2, and Port 3) for transmission of a CSI-RS. In this grid, each row shows the portion of the precoder that the base station generates for a corresponding port; and each column n shows the portion of the precoder that the base station generates for a corresponding FD unit, where n=[0, . . . , N−1]. Thus, in the illustrated example, for Port 0, the base station generates a spatial domain precoder b₀ as well as a frequency domain basis vector f₀^{H}.

The particular combination of spatial domain basis vector and frequency domain basis vector shown in FIG. 6A is merely illustrative in nature. In general, each spatial domain basis vector may be paired with a different frequency domain basis vector. That is, the spatial domain beam may be observed at different taps. In the illustrated example, Port 0 and Port 1 both have the same spatial domain basis vector, but different frequency domain basis vectors. But other combinations of spatial domain basis vectors and frequency domain basis vectors may be employed in a given implementation.

The example depicted in FIG. 6A illustrates a base station-generated precoder for a specific sets of ports (in the example, four ports—Ports 0 through 3). The base station may also generate a precoder applicable to a larger number of ports, such as when implementing SD and FD port emulation. In that case, the base station may be configured to generate a number of ports using port emulation up to a maximum number of K ports.

Consequently, using such port emulation techniques, the base station may generate a precoder for Ports 0 through K−1, where K is the number of ports. In this arrangement, the ports are not necessarily arranged in increasing levels of polarization as may be the case in Rel-16 type precoders.

To illustrate, FIG. 6B depicts a grid that schematically shows one example of a base station-generated part of a Rel-17 Type II precoder, applied to a number of ports determined by the value of K. Specifically, the ports run from a first port 0 up to port K−1, where K is the total number of ports. In the illustrated table, each row shows a portion of a precoder the base station generates for a corresponding port; and each column n (where n=[0, N−1]) shows the precoder the base station generates for a corresponding FD unit.

Having established a precoding scheme, the base station may transmit a precoded DL reference signal (e.g., CSI-RS) to a UE for CSI, wherein the CSI-RS is precoded according to the established precoding scheme. After receipt of the precoded CSI-RS, the UE generates a corresponding channel estimate.

In general, the generation of the channel estimate involves the UE measuring the amplitude and phase of signals received for each port and each FD unit of each port in the received CSI-RS. The UE encodes the measured amplitude and phase values into a data matrix, where each row of the matrix represents a particular port and each column a different FD unit. Typically, the amplitude and phase measurements generated by the UE are high resolution. As such, if the UE were to transmit the raw measured data to the base station in the form of a CSI report, the CSI report would contain a relatively large amount of data potentially causing substantial overhead in data transmissions between the UE and base station. To reduce the overhead, the UE may be configured to quantize the values (i.e., amplitude and phase) contained within the CSI report to reduce the size of the CSI report or otherwise facilitate processing of the received CSI report by the base station.

For example, quantization of the amplitude values in a CSI report may involve the UE mapping each measured amplitude to one of a relatively small set of discrete predetermined amplitude values. For example, the UE may perform 4-bit quantization in which the 4-bits are used to define 16 different discrete signal amplitude values in a predetermined range (e.g., ranging from 0 dB to −22.5 dB in step sizes of −1.5 dB). Alternatively, the UE may perform 3-bit quantization in which the 3-bits are used to define 8 different discrete signal amplitude values in a predetermined range (e.g., ranging from 0 dB to −21 dB in step sizes of −3 dB). The UE then performs quantization for a measured amplitude value by replacing the measured amplitude value with the closest of the 8 quantized amplitude values. In various quantization schemes, the UE may be configured to perform different quantization approaches in which different numbers of quantized values are defined. For example, a UE may alternatively (or in addition) perform 4-bit quantization, in which amplitude values are quantized to one of 16 different predetermined quantized amplitude values. Other quantization schemes may involve applying 8-bit quantization or 2-bit quantization, for example.

In a similar manner, the UE may also be configured to perform quantization of the measured phase values. For example, each measured phase value in the CSI report may be quantized using phase shift keying (PSK) techniques. For example, the UE may quantize the phase values using 8PSK or 16PSK alphabets. When using an 8PSK alphabet, for example, the alphabet establishes 8 phase hypotheses that are distributed evenly throughout phases from 0 to 2 π. With the phase hypotheses so defined, phase quantization requires, for each measured phase value, selecting the phase hypothesis established by the 8PSK alphabet that is closest to the measured phase value. Similarly, when using a 16PSK alphabet, for example, the alphabet establishes 16 phase hypotheses that are distributed evenly throughout phases from 0 to 2 π. With the phase hypotheses so defined, phase quantization requires, for each measured phase value, selecting the phase hypothesis established by the 16PSK alphabet that is closest to the measured phase value.

In addition to quantizing the data values in the CSI report, the UE may also perform steps of normalizing the amplitude values in the CSI report around a particular value (e.g., a highest amplitude value that the UE measured during channel measurement) or applying reference value multipliers to subsets of values in the CSI report in order to increase differentiation between higher and lower amplitude values in the CSI report or to further differentiate amplitude measurements between port groupings having different polarizations.

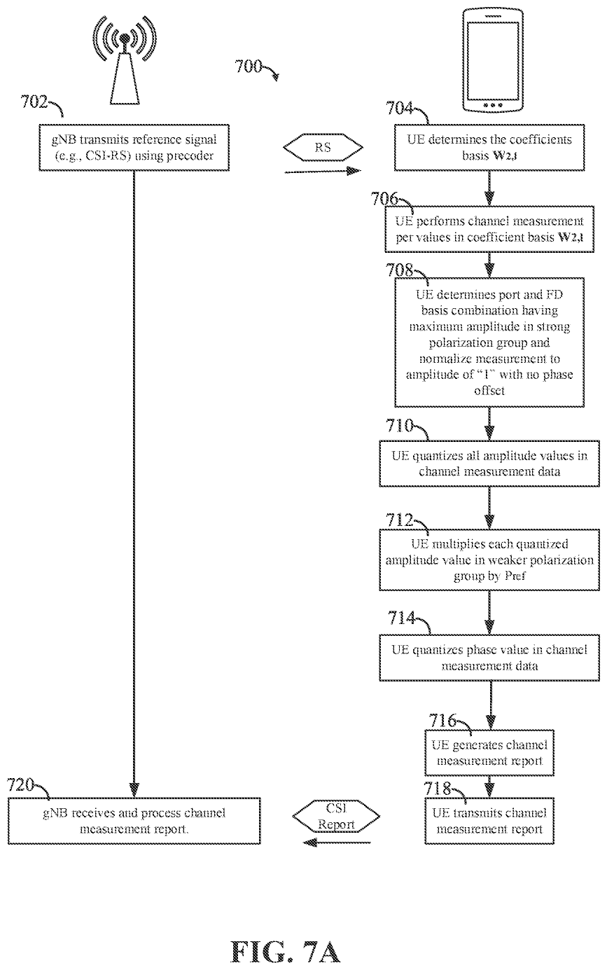

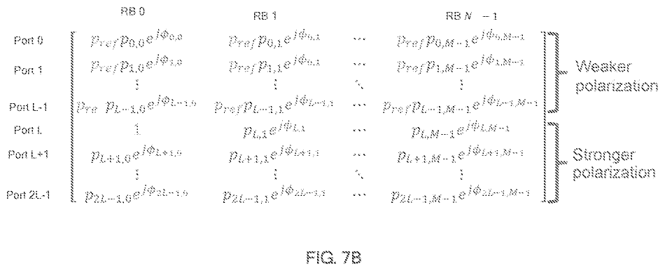

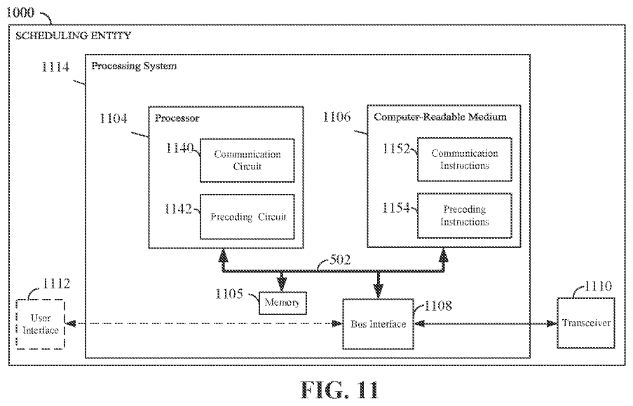

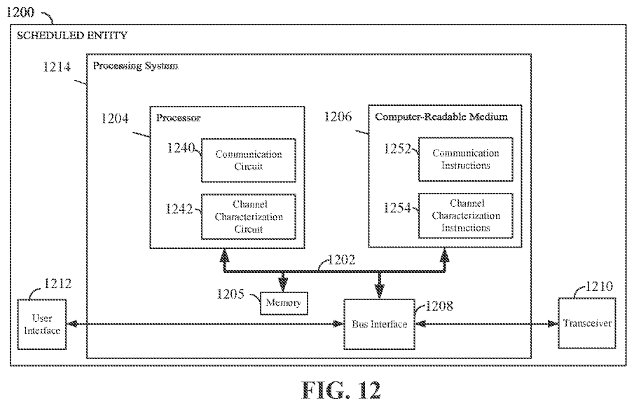

To illustrate, FIG. 7A is a flow chart illustrating an exemplary process 700 for a UE to process channel measurement data for generation of a CSI report. In some examples, the process 700 may be carried out by the scheduling entity 1100 illustrated in FIG. 11, below, and the scheduled entity 1200 illustrated in FIG. 12, below. In some examples, the process 700 may be carried out by any suitable apparatus or means for carrying out the functions or algorithm described below. As described below, some or all illustrated features may be omitted in a particular implementation within the scope of the present disclosure.

At block 702, the base station transmits a precoded CSI-RS to the UE. In step 704, the UE determines the coefficients basis \tilde{W}_{2,l} of the precoder that the base station used to precode the CSI-RS. An identification of the coefficient basis \tilde{W}_{2,l} may be communicated to the UE, where the coefficients basis \tilde{W}_{2,l} is determined by the base station based upon UE feedback derived from UE beam measurements. For the precoding scheme, the coefficient basis \tilde{W}_{2,l} is a two-dimensional array specifying coefficients for each port in the precoding scheme and each FD basis component in each port.

Having determined the coefficient basis \tilde{W}_{2,l}, in step 706 the UE performs channel measurement for each port and FD basis component combination associated with a non-zero coefficient in the coefficient basis \tilde{W}_{2,l}. The UE may store the measured values in a two-dimensional data array wherein rows in the array are associated with different ports and columns in the array are associated with different FD basis components. Having generated raw amplitude and phase measurements for each port and FD basis component combination in the precoding scheme associated with non-zero coefficients in the coefficient basis \tilde{W}_{2,l}, the UE may quantize and normalize the stored data.

In some precoding schemes, such as the release-16 Type II precoder described above with respect to FIG. 5C, the ports are arranged in increasing polarization strength. This enables the UE to further adjust the quantized values in the data array based on polarization strength of each port to provide quantization differentiation. Specifically, in a release-16 Type II precoder, ports are numbered from 0 to 2 L−1, where L is the number of spatial linear beams generated by the base station. The precoder is sorted according to increasing levels of polarization where the initial ports in the precoder (e.g., ports ranging from Port 0 to Port L−1) may exhibit reduced levels of polarization with respect to ports occurring later in the precoder (e.g., ports ranging from Port L to Port 2 L−1).

In step 708, the UE determines the port and FD basis component combination having the highest amplitude measured in the group of ports belonging to the “strong polarization” port group—ports numbered from L to 2 L−1. The highest measured amplitude and phase of the strong polarization port group is then normalized to an amplitude of “1” (i.e., 0 dB) with no phase offset.

In step 710, the UE quantizes all amplitude data in the values measured in step 706 and stored in the data array (the UE may not quantize the amplitude that was normalized to a value of “1” in step 708. In step 710, the amplitude values may be quantized, as discussed herein, using any suitable quantization scheme. In one example, the amplitude data is quantized into 8 different amplitude values (e.g., 3-bit quantization) having discrete magnitudes ranging from 0 dB to −21 dB in step sizes of −3 dB. In other implementations, different quantization schemes, as known to persons of ordinary skill in the art, may be used to quantize the measured amplitude values.

To achieve differentiation between the quantized values in the weaker polarization group of ports (i.e., ports numbered 0 to L−1) and the stronger polarization group of ports (i.e., ports numbered L to 2 L−1), in step 712, the UE multiplies each quantized amplitude for each combination of port and FD basis component in the weak polarization group of ports by a reference power value P_{ref}. P_{ref} may be a system value predetermined by the base station or UE.

In step 714 the UE quantizes the measured phases for each port and FD basis component combination in the data array (except for the phase measurement that was set to zero in step 708). This step may involve the UE quantizing phase measurements by application of PSK encoding (e.g., via an 8PSK or 16PSK alphabet), though other approaches for quantizing phase data may be utilized. The quantized phase measurements are then normalized as offsets from the phase of the port and FD basis component combination having the highest amplitude measured in the group of ports belonging to the “strong polarization” port group (i.e., a phase of 0). The phase may be normalized by subtracting the quantized phase of the port and FD basis component combination having the highest amplitude measured in the group of ports belonging to the “strong polarization” port group from the quantized phase value of each port and FD basis component combination in the data array.

In step 716 UE generates a CSI report based on the quantized and normalized channel measurement data and transmits the CSI report to the base station in step 718. The base station receives and processes the CSI report in step 720.

To illustrate, FIG. 7B shows one example of a data array depicting channel state measurements quantized and normalized by a UE according to the method depicted in FIG. 7A. As illustrated the channel state data is arranged in a two-dimensional array where rows in the array are associated with different ports and columns in the array are associated with different FD basis components. The ports in the array are arranged from 0 to 2 L−1 wherein ports ranging from 0 to L−1 are associated with weak polarizations and ports ranging from L to 2 L−1 are associated with strong polarizations. In this example, the amplitude associated with the port and FD basis component combination having the highest amplitude has been normalized to an amplitude value of “1” (i.e., 0 dB) with no phase offset (e.g., as in step 708, FIG. 7A). A value P_{ref}, is applied (e.g., via multiplication) to modify each amplitude value belonging to a port in the weaker polarization group. Additionally, all amplitude (e.g., P_{0,0} through P_{2L-1, M-1}) and phase (e.g., e^{jϕ}^{_{0,0}} through e^{jϕ}^{_{2L-1,M-1}}) values in the depicted array have been quantized (e.g., in accordance with steps 710 and 714, FIG. 7A).

The process 700 depicted in FIG. 7A for processing data for a CSI report presumes that the port sequence in the precoder orders ports from those having weakest polarization to ports having stronger polarization. But other precoders (e.g., the Rel-17 Type II precoder) do not sort ports by polarization strength or do not provide explicit definitions of ‘polarization.’ As such, some aspects of the present disclosure provide for precoders that employ quantization schemes that do not rely on knowledge of polarization strength for different ports.

For example, a precoder may be configured to implement aspects of the Rel-16 codebook structure in which a precoder for subband n may be described according to the following equation.

Σᵢ₌₀^{P-1}Σₘ₌₀^{M-1}xᵢ·c_{i,m}·fₘ^{H}[n]

In this version of the Rel-16 codebook structure, element xᵢ may be assigned a value of 1 or 0 depending on port selections, fₘ^{H}[n] is the frequency domain basis on subband n, and c_{i,m} is the set of linear combination coefficients. As illustrated, however, the entries in the code book are not sorted by spatial linear beams generated by the base station (L), which are sorted in the polarization strength. Instead, the code book is sorted by groups of ports (P), where the port grouping does not imply any polarization strength sorting. Other codebook structures (e.g., the Rel-15 codebook) also do convey polarization information in the structure of the codebook. Consequently, quantization schemes that do not rely on polarization are provided.

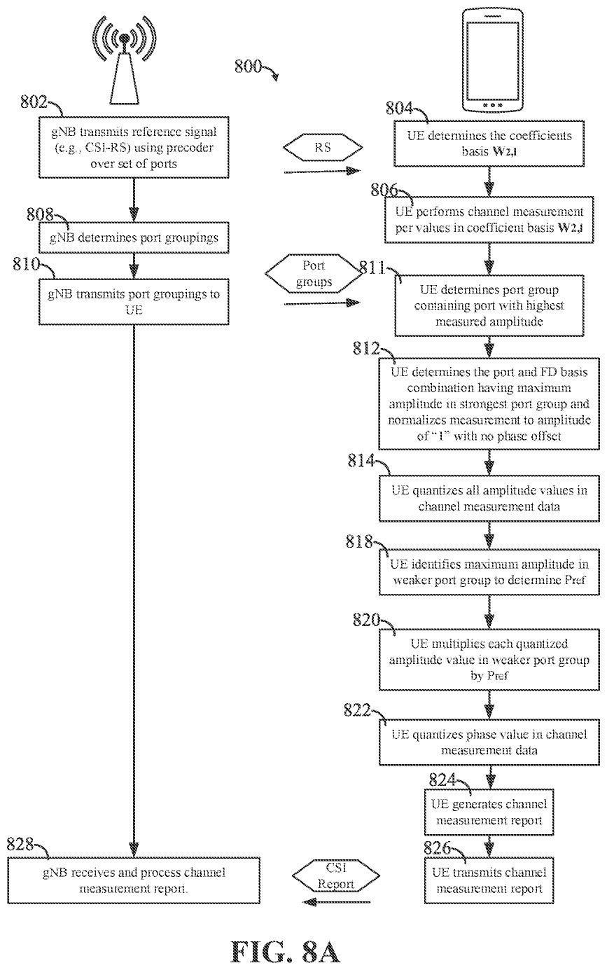

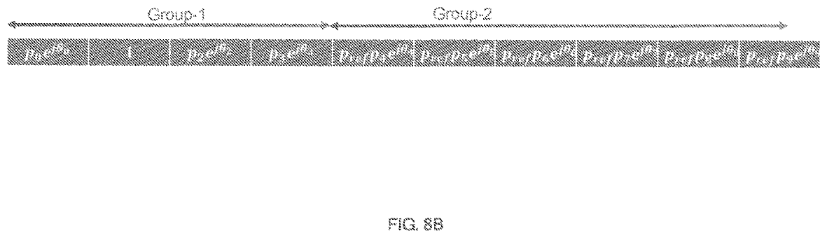

To illustrate, FIG. 8A is a flow chart illustrating an exemplary process 800 for a UE to quantize channel measurement according to port groupings. In some examples, the process 800 may be carried out by the scheduling entity 1100 illustrated in FIG. 11, below, and the scheduled entity 1200 illustrated in FIG. 12, below. In some examples, the process 800 may be carried out by any suitable apparatus or means for carrying out the functions or algorithm described below. As described below, some or all illustrated features may be omitted in a particular implementation within the scope of the present disclosure.

At block 802, the base station transmits a precoded CSI-RS to the UE. The precoded CSI-RS is transmitted over a set of ports. The precoding scheme used to precode the CSI-RS need not convey polarization information for the ports over which the CSI-RS is transmitted.

The UE, in step 804, determines the coefficients basis \tilde{W}_{2,l} of the precoder that the base station used to precode the CSI-RS. In some cases, the coefficients basis \tilde{W}_{2,l} of the precoder can be identified in signaling from the base station to the UE. For the precoding scheme, the coefficient basis \tilde{W}_{2,l} is a two-dimensional array specifying coefficients for each port in the precoding scheme and each FD basis component in each port.

Having determined the coefficient basis \tilde{W}_{2,l}, in step 806 the UE performs channel measurement for each port and FD basis component combination associated with a non-zero coefficient in the coefficient basis \tilde{W}_{2,l}. The UE stores the measured values in a two-dimensional data array wherein rows in the array are associated with different ports and columns in the array are associated with different FD basis components. Having generated raw amplitude and phase measurements for each port and FD basis component combination in the precoding scheme associated with non-zero coefficients in the coefficient basis \tilde{W}_{2,l}, the UE quantizes and normalizes the stored data.

Separately, in step 808, the base station determines a set of groupings for the ports over which the CSI-RS was transmitted in step 802. Generally, the base station may use any suitable approach for determining groups of CSI-RS ports. In some examples, the base station separates the ports over which it transmits the CSI-RS into groups by identifying a group of ports that includes wideband-only CSI-RS ports precoding and another group of ports that consists of CSI-RS ports with FD precoding. In other cases, the base station may determine the port groupings based upon signaling received from the UE that identifies which ports have the strongest signal level. In that case, the ports may be grouped based on signal level amplitudes in which ports with similar signal level amplitudes are grouped together. For example, the base station may determine an average signal level over all ports and then group ports associated with signal levels lower than average in a first group and ports associated with signal levels greater than average in a second group. In an alternative embodiment, the UE can independently group the CSI-RS ports based upon received signal strength and then inform the base station of the determined groupings via signaling. Although an example is presented in which two groupings of the CSI-RS ports are established (either by the base station in step 808 or, alternatively, by the UE), it should be understood that the CSI-RS ports may be arranged in a different number of groupings (i.e., three or more) depending upon the system implementation. In step 810, the base station transmits an identification of the port groupings to the UE. In general, the port groupings identify a first set of ports (e.g., Ports 0, 1, 2, 3) that belong to a first port group and a second set of ports (e.g., Ports 4, 5, 6, 7, 8, 9) that belong to a second port group. Ports belonging to a first port group will not be included in another port group.

In step 811, the UE determines which port group contains the port with the highest measured amplitude of all ports over which the CSI-RS was received. This port group can be referred to as the strongest port group.

In step 812 the UE determines the port and FD basis component combination having the highest amplitude measured in the group of ports identified as the strongest port group (i.e., the port group identified in step 811). The other identified port group (i.e., the port group that does not contain the port with the highest measured amplitude) is referred to as the weak port group. The highest measured amplitude and phase of a port in the strongest port group is normalized to an amplitude of “1” (i.e., 0 dB) with no phase offset in the channel state report transmitted in step 826, below.

In step 814, the UE quantizes all amplitude data in the values measured in step 806 and stored in the data array. In step 814, the amplitude values may be quantized, as discussed herein, using any suitable quantization scheme. In one example, the amplitude data is quantized into 8 different amplitude values (e.g., 3-bit quantization) having discrete magnitudes ranging from 0 dB to −21 dB in step sizes of −3 dB. In other implementations, different quantization schemes, as known to persons of ordinary skill in the art, may be used to quantize the measured amplitude values. In some embodiments the measured values for each port group are quantized and can optionally be normalized relative to the strongest amplitude values measured for each port group. In the port grouping that contains a port having the highest measured amplitude, for example, the measured amplitudes may be quantized and normalized relative to the maximum measured amplitude. Normalization may involve, for each port group, subtracting the maximum measured amplitude for that port group from all other amplitude values for other ports in the same subgroup. The amplitude values may be normalized before or after quantization. Accordingly, step 814 involves the UE determining the highest amplitude measured in each port group and the highest amplitude of each port group may be used to normalize the measured and quantized amplitude values for ports in the same port group.

To achieve differentiation between the quantized amplitude values in the weaker port grouping from those in the stronger port grouping, the UE multiplies the quantized amplitude for combinations of port and FD basis components in the weaker port group by a reference power value P_{ref}.

Specifically, in step 818, the UE determines the highest amplitude measured for a port in the weak port group. The highest amplitude (now quantized) is set to the value of P_{ref}. Alternatively, P_{ref} may be a value equal to the highest quantized amplitude of the weaker port group divided by the high quantized amplitude of the strongest port group. In either case, in step 820, the value P_{ref} is applied (e.g., via multiplication) to each measured amplitude in the weak port group to modify the measured amplitude values. Optionally, P_{ref} may not be applied to the port having the highest amplitude measured for the weak port group. In some embodiments, different approaches for calculating the value P_{ref} may be utilized. For example P_{ref} may be selected or optimized to provide a global minimization of quantization error.

In step 822 the UE quantizes the measured phases for each port and FD basis component combination in the data array. This step may involve the UE quantizing phase measurements by application of PSK encoding (e.g., via an 8PSK or 16PSK alphabet), though other approaches for quantizing phase data may be utilized. The quantized phase measurements are then normalized as offsets from the phase of the port and FD basis component combination having the highest amplitude. This may involve dividing each quantized phase measurement for ports in a first port group by the quantized phase measurement for the port and FD basis component combination having the highest amplitude in the same port group. Alternatively, normalization of quantized phase values may involve subtracting the quantized phase measurement for the port and FD basis component combination having the highest amplitude in a first port group from the quantized phase measurements for other port and FD basis component combinations in the same port group.

In step 824 UE generates a CSI report based on the quantized and normalized channel measurement data and transmits the CSI report to the base station in step 826. The base station receives and processes the CSI report in step 828.

To illustrate, FIG. 8B shows one example of a data array depicting channel state measurements quantized and normalized by a UE according to the method depicted in FIG. 8A. As illustrated the channel state data is arranged in two groups (as designated by the base station in steps 808 and 810, FIG. 8A). In the first port grouping (designated as the “strong port group”) the amplitude associated with the port and FD basis component combination having the highest amplitude has been normalized to an amplitude value of “1” (i.e., 0 dB) with no phase offset (e.g., as in step 812, FIG. 8A). A value P_{ref}, is calculated based upon the highest amplitude (i.e., P₆) measured in the second port grouping (designated as the “weak port group”) and applied (e.g., via multiplication) to modify each amplitude value belonging to a port in the second port group. Additionally, all amplitudes are quantized (e.g., in accordance with step 822, FIG. 8A).

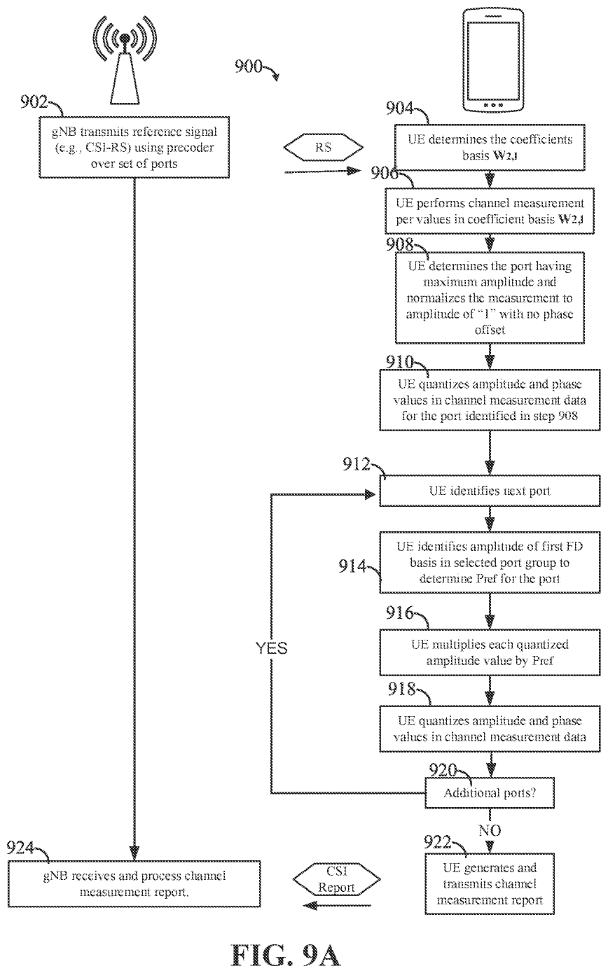

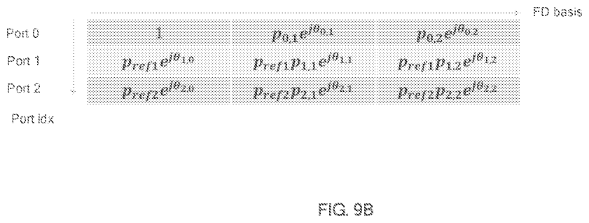

An alternate quantization scheme that does not require knowledge of port polarizations is presented in FIG. 9A and illustrated in FIG. 9B. Specifically, FIG. 9A is a flow chart illustrating an exemplary process 900 for a UE to quantize channel measurements. In some examples, the process 900 may be carried out by the scheduling entity 1100 illustrated in FIG. 11, below, and the scheduled entity 1200 illustrated in FIG. 12, below. In some examples, the process 900 may be carried out by any suitable apparatus or means for carrying out the functions or algorithm described below. As described below, some or all illustrated features may be omitted in a particular implementation within the scope of the present disclosure.

At block 902, the base station transmits a precoded CSI-RS to the UE. The precoded CSI-RS is transmitted over a set of ports. The precoding scheme used to precode the CSI-RS does not convey polarization information for the ports over which the base station transmits the CSI-RS.

The UE, in step 904, determines the coefficients basis \tilde{W}_{2,l} of the precoder that the base station used to precode the CSI-RS. An identification of the coefficients basis \tilde{W}_{2,l} may be transmitted from the base station to the UE. For the precoding scheme, the coefficient basis \tilde{W}_{2,l} is a two-dimensional array specifying coefficients for each port in the precoding scheme and each FD basis component in each port.

Having determined the coefficient basis \tilde{W}_{2,l}, in step 906 the UE performs channel measurement for each port and FD basis component combination associated with a non-zero coefficient in the coefficient basis \tilde{W}_{2,l}. The UE stores the measured values in a two-dimensional data array wherein rows in the array are associated with different ports and columns in the array are associated with different FD basis components. Having generated raw amplitude and phase measurements for each port and FD basis component combination in the precoding scheme associated with non-zero coefficients in the coefficient basis \tilde{W}_{2,l}, the UE quantizes and normalizes the stored data.

In step 908 the UE determines the port and FD basis component combination having the highest amplitude of all ports. The highest measured amplitude and phase of the strongest port and FD basis component combination is normalized to an amplitude of “1” (i.e., 0 dB) with no phase offset in the channel state report transmitted in step 922, below. In some embodiments, step 908 involves only analyzing the first FD basis component of each port to identify which first FD basis component of each port has the highest amplitude. Such an implementation may presume that the first FD basis component of any port will always have the highest amplitude out of all other FD basis components of the port.

In step 910, the amplitude and phase of other FD basis components of the port identified in step 908 are quantized and normalized to the amplitude and phase values for the FD basis component that was identified in step 908. Relative quantization may involve normalizing the amplitude values of the FD basis components in the port based upon the highest measurement amplitude (which is normalized to a value of “1”) and then quantizing the normalized values using a suitable quantization scheme. Alternatively, relative quantization may involve first quantizing all amplitude values for each FD basis component of the port and then normalizing the values by subtracting the largest quantized amplitude from the other quantized amplitude values. Phase measurements for the port's FD basis components can be quantized (e.g., using a PSK alphabet such as 8PSK or 16PSK) and normalized to the quantized phase measurement of the FD basis component identified in step 908. Normalization may involve dividing the quantized phase measurements for each FD basis component by the quantized phase measurement of the FD basis component identified in step 908. Alternatively, phase normalization may involve subtracting the quantized phase measurement of the FD basis component identified in step 908 from the quantized phase measurements for the other FD basis components in the port.

The UE iterates through remaining ports in the channel measurement to perform quantization on each remaining port. Specifically, in step 912 the UE identifies the next port in the channel measurement.

In step 914, the UE determines the amplitude of the first FD basis component measurement of the port and sets that amplitude value as P_{ref} for that specific port. In step 916, the UE multiplies the P_{ref} value determined in step 914 by the amplitudes measured for all other FD basis component measurement of the port. In step 918, the amplitude values, now modified by the application of the P_{ref} value can then be normalized by the UE based upon the highest measured amplitude (e.g., identified in step 914) and then quantized using a suitable quantization scheme. Alternatively, this process may include first quantizing all amplitude values for each FD basis component of the port and then normalizing the values by subtracting the largest quantized amplitude from the other quantized amplitude values.

Additionally, in step 918, the UE quantizes the measured phases for each FD basis component of the port. This step may involve the UE quantizing phase measurements by application of PSK encoding (e.g., via an 8PSK or 16PSK alphabet), though other approaches for quantizing phase data may be utilized. The quantized phase measurements are then normalized as offsets from the phase of the FD basis component of the port having the highest amplitude. Phase normalization may involve dividing each quantized phase measurement for FD basis components of the port by the quantized phase measurement for the FD basis component of the port having the highest amplitude. Alternatively, normalization of quantized phase values may involve subtracting the quantized phase measurement for the FD basis component having the highest amplitude from the quantized phase measurements for other FD basis components in the same port.

In step 920, the UE determines whether there are additional ports to process in the measurement data. If so, the method returns to step 912 so that the data for remaining ports is quantized. If there are no additional ports to process, the UE generates a CSI report based on the quantized and normalized channel measurement data and transmits the CSI report to the base station in step 922. The base station receives and processes the CSI report in step 924.

To illustrate, FIG. 9B shows one example of a data array depicting channel state measurements quantized and normalized by a UE according to the method depicted in FIG. 9A. As illustrated the UE identified a first port (e.g., Port 0) as the port having the FD basis component with the highest amplitude of all port measurements. Accordingly, the UE normalized the value in the first FD basis component for that port to an amplitude value of “1” with no phase offset (e.g., as in step 908, FIG. 9A). The UE quantizes and normalizes the amplitude and phase measurements for the other FD basis components in that port relative to the FD basis component that the UE normalized to the value of “1” with no phase offset.

The other ports in the channel state measurements are also processed in accordance with the method of FIG. 9A. Accordingly, the measurements for all ports depicted in FIG. 9B (other than for the port that had FD basis components with the highest amplitude) are quantized and normalized so that the amplitude of each first FD basis for each port is designated as a reference value (e.g., P_{ref}) that is applied to the other FB basis elements of the port. Accordingly, the amplitude of the first FD basis component for port 1 is designated as a reference value P_{ref1}, which is applied to the other FD basis components for port 1 as shown. Similarly, the amplitude of the first FD basis component for port 2 is designated as a reference value Prep, which is applied to the other FD basis components for port 2 as shown.

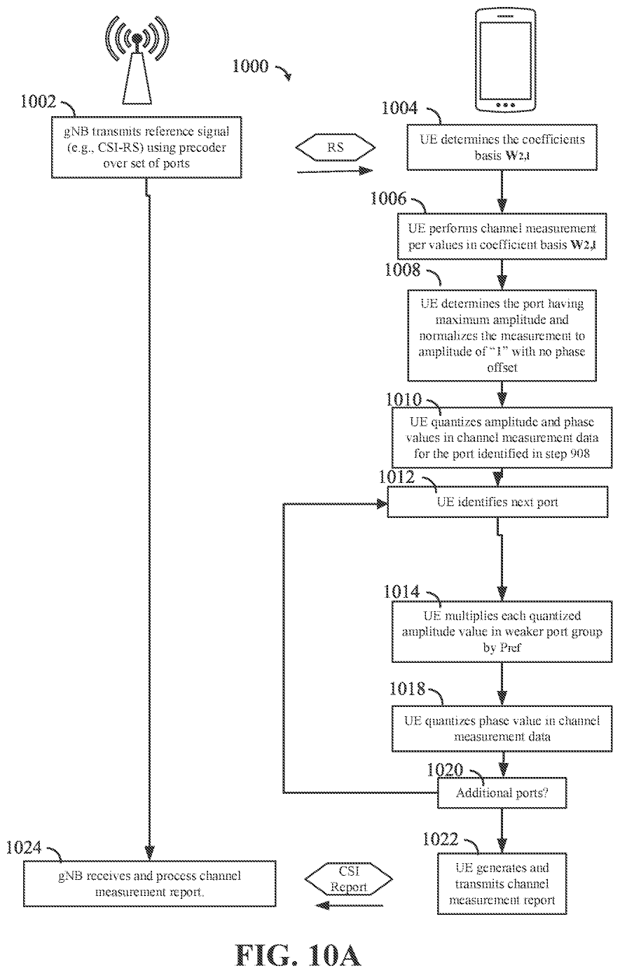

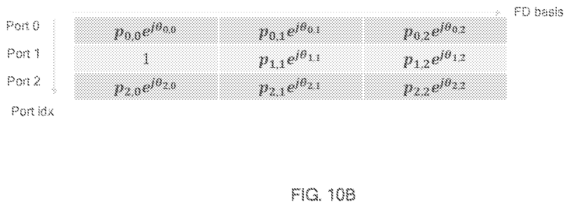

FIG. 10A is a flow chart illustrating an exemplary process 1000 for a UE to quantize channel measurements. In some examples, the process 1000 may be carried out by the scheduling entity 1100 illustrated in FIG. 11, below, and the scheduled entity 1200 illustrated in FIG. 12, below. In some examples, the process 1000 may be carried out by any suitable apparatus or means for carrying out the functions or algorithm described below. As described below, some or all illustrated features may be omitted in a particular implementation within the scope of the present disclosure.

At block 1002, the base station transmits a precoded CSI-RS to the UE. The precoded CSI-RS is transmitted over a set of ports. The precoding scheme used to precode the CSI-RS does not convey polarization information for the ports over which the base station transmits the CSI-RS.

The UE, in step 1004, determines the coefficients basis \tilde{W}_{2,l} of the precoder that the base station used to precode the CSI-RS. An identification of the coefficients basis \tilde{W}_{2,l} may be transmitted from the base station to the UE. For the precoding scheme, the coefficient basis \tilde{W}_{2,l} is a two-dimensional array specifying coefficients for each port in the precoding scheme and each FD basis component in each port.

Having determined the coefficient basis \tilde{W}_{2,l}, in step 1006 the UE performs channel measurement for each port and FD basis component combination associated with a non-zero coefficient in the coefficient basis \tilde{W}_{2,l}. The UE stores the measured values in a two-dimensional data array wherein rows in the array are associated with different ports and columns in the array are associated with different FD basis components. Having generated raw amplitude and phase measurements for each port and FD basis component combination in the precoding scheme associated with non-zero coefficients in the coefficient basis \tilde{W}_{2,l}, the UE quantizes and normalizes the stored data.

In step 1008 the UE determines the port and FD basis component combination having the highest amplitude of all ports. The highest measured amplitude and phase of the strongest port and FD basis component combination is normalized to an amplitude of “1” (i.e., 0 dB) with no phase offset in the channel state report transmitted in step 1022, below.

In step 1010, the amplitude and phase of other FD basis components of the port identified in step 1008 are relatively quantized to the FD basis component identified in step 1008. Relative quantization may involve normalizing the amplitude values of the FD basis components in the port based upon the highest measured amplitude and then quantizing the normalized values using a suitable quantization scheme. Alternatively, relative quantization may involve first quantizing all amplitude values for each FD basis component of the port and then normalizing the values by subtracting the largest quantized amplitude from the other quantized amplitude values. The phase measurements are relatively quantized by subtracting the quantized phase of the port having the highest measured amplitude from the quantized phase measurements of the other FD basis components of the port.

The UE iterates through remaining ports in the channel measurement to perform quantization on each remaining port. Specifically, in step 1012 the UE identifies the next port in the channel measurement. In step 1014, the UE determines the amplitude of the first FD basis component measurement of the port and quantizes the remaining FD basis amplitudes for the port. This quantization is relative to the amplitude of the first FD basis component measurement in that the quantization may involve normalizing the amplitude values of the FD basis components in each port based upon the highest measurement amplitude of the port and then quantizing the normalized values using a suitable quantization scheme. Alternatively, quantization may involve first quantizing all amplitude values for each FD basis component of the port and then normalizing the values by subtracting the largest quantized amplitude from the other quantized amplitude values.

In step 1018, the UE quantizes the measured phases for each FD basis component of the port. This step may involve the UE quantizing phase measurements by application of PSK encoding (e.g., via an 8PSK or 16PSK alphabet), though other approaches for quantizing phase data may be utilized. The quantized phase measurements are then normalized as offsets from the phase of the FD basis component of the port having the highest amplitude. Phase normalization may involve dividing each quantized phase measurement for FD basis components of the port by the quantized phase measurement for the FD basis component of the port having the highest amplitude. Alternatively, normalization of quantized phase values may involve subtracting the quantized phase measurement for the FD basis component having the highest amplitude from the quantized phase measurements for other FD basis components in the same port.

In step 1020, the UE determines whether there are additional ports to process in the measurement data. If so, the method returns to step 1012 so that the data for remaining ports is quantized. If there are no additional ports to process, the UE generates a CSI report based on the quantized and normalized channel measurement data and transmits the CSI report to the base station in step 1022. The base station receives and processes the CSI report in step 1024.

To illustrate, FIG. 10B shows one example of a data array depicting channel state measurements quantized and normalized by a UE according to the method depicted in FIG. 10A. As illustrated the UE identified a first port (e.g., Port 1) as the port having the FD basis component with the highest amplitude of all port measurements. Accordingly, the UE normalized the value in the first FD basis component for that port to an amplitude value of “1” with no phase offset (e.g., as in step 1008, FIG. 10A). The UE quantizes and normalizes the amplitude and phase measurements for the other FD basis components in that port relative to the FD basis component that the UE normalized to the value of “1” with no phase offset.

The other ports in the channel state measurements are also processed in accordance with the method of FIG. 10A. Accordingly, the measurements for all ports depicted in FIG. 10B (other than for the port that had FD basis components with the highest amplitude) are quantized and normalized so that the amplitude of each FD basis is quantized relative to the amplitude of the first FD basis component in each port. This may involve normalizing the amplitude values of the FD basis components in the port based upon the highest measurement amplitude and then quantizing the normalized values using a suitable quantization scheme. Alternatively, relative quantization may involve first quantizing all amplitude values for each FD basis component of the port and then normalizing the values by subtracting the largest quantized amplitude from the other quantized amplitude values. Phase measurements for the port's FD basis components can be quantized (e.g., using a PSK alphabet such as 8PSK or 16PSK) and normalized to the quantized phase measurement of the FD basis component identified in step 908. Phase normalization may involve dividing each quantized phase measurement for FD basis components of the port by the quantized phase measurement for the FD basis component of the port having the highest amplitude. Alternatively, normalization of quantized phase values may involve subtracting the quantized phase measurement for the FD basis component having the highest amplitude from the quantized phase measurements for other FD basis components in the same port.

By employing some of the aspects described herein, a UE may quantize channel state measurement reports when reference signals are precoded using codebooks that do not include polarization definitions or information. The quantization approaches illustrated in FIGS. 8A, 8B, 9A, 9A, 10A, and 10B do not rely on polarization information and so can be, used relative to non-polarization-based codebooks.

FIG. 11 is a block diagram illustrating an example of a hardware implementation for a scheduling entity 1100 employing a processing system 1114. For example, the scheduling entity 1100 may be a user equipment (UE) as illustrated in any one or more of FIGS. 1, 2, and/or 4. In another example, the scheduling entity 1100 may be a base station as illustrated in any one or more of FIGS. 1, 2, and/or 4.

The scheduling entity 1100 may be implemented with a processing system 1114 that includes one or more processors 1104. Examples of processors 1104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 1100 may be configured to perform any one or more of the functions described herein. That is, the processor 1104, as utilized in a scheduling entity 1100, may be configured (e.g., in coordination with the memory 1105) to implement any one or more of the processes and procedures described below and illustrated in FIG. 11.

In this example, the processing system 1114 may be implemented with a bus architecture, represented generally by the bus 1102. The bus 1102 may include any number of interconnecting buses and bridges depending on the specific application of the processing system 1114 and the overall design constraints. The bus 1102 communicatively couples together various circuits including one or more processors (represented generally by the processor 1104), a memory 1105, and computer-readable media (represented generally by the computer-readable medium 1106). The bus 1102 may also link various other circuits such as timing sources, peripherals, voltage regulators, and power management circuits, which are well known in the art, and therefore, will not be described any further. A bus interface 1108 provides an interface between the bus 1102 and a transceiver 1110. The transceiver 1110 provides a communication interface or means for communicating with various other apparatus over a transmission medium. Depending upon the nature of the apparatus, a user interface 1112 (e.g., keypad, display, speaker, microphone, joystick) may also be provided. Of course, such a user interface 1112 is optional, and may be omitted in some examples, such as a base station.

In some aspects of the disclosure, the processor 1104 may include communication circuitry 1140 configured (e.g., in coordination with the memory 1105 and the transceiver 1110) for various functions, including, e.g., transmitting and/or receiving data, control signaling, and reference signals over a wireless air interface. The processor 1104 may further include precoding circuitry 1142 configured (e.g., in coordination with the memory 1105 and the transceiver 1110) for various functions, including, e.g., determining and applying a precoding matrix to a transmission.

The processor 1104 is responsible for managing the bus 1102 and general processing, including the execution of software stored on the computer-readable medium 1106. The software, when executed by the processor 1104, causes the processing system 1114 to perform the various functions described below for any particular apparatus. The computer-readable medium 1106 and the memory 1105 may also be used for storing data that is manipulated by the processor 1104 when executing software.

One or more processors 1104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1106. The computer-readable medium 1106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1106 may reside in the processing system 1114, external to the processing system 1114, or distributed across multiple entities including the processing system 1114. The computer-readable medium 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 1106 may store computer-executable code that includes communication instructions 1160 that configure a scheduling entity 1100 for various functions, including, e.g., transmitting and/or receiving data, control signaling, and reference signals over a wireless air interface. The computer-readable storage medium 1106 may store computer-executable code that includes channel characterization instructions 1162 that configure a scheduling entity 1100 for various functions, including, e.g., determining and applying a precoding matrix to a transmission.

Of course, in the above examples, the circuitry included in the processor 1104 is merely provided as an example, and other means for carrying out the described functions may be included within various aspects of the present disclosure, including but not limited to the instructions stored in the computer-readable storage medium 1106, or any other suitable apparatus or means described in any one of the FIGS. 1, 2, and/or 4, and utilizing, for example, the processes and/or algorithms described herein in relation to FIGS. 8A-8C.

FIG. 12 is a conceptual diagram illustrating an example of a hardware implementation for an exemplary scheduled entity 1200 employing a processing system 1214. In accordance with various aspects of the disclosure, an element, or any portion of an element, or any combination of elements may be implemented with a processing system 1214 that includes one or more processors 1204. For example, the scheduled entity 1200 may be a user equipment (UE) as illustrated in any one or more of FIGS. 1, 2, and/or 4.

The processing system 1214 may be substantially the same as the processing system 1114 illustrated in FIG. 11, including a bus interface 1208, a bus 1202, memory 1205, a processor 1204, and a computer-readable medium 1206. Furthermore, the scheduled entity 1200 may include a user interface 1212 and a transceiver 1210 substantially similar to those described above in FIG. 11. That is, the processor 1204, as utilized in a scheduled entity 1200, may be configured (e.g., in coordination with the memory 1205) to implement any one or more of the processes described below and illustrated in FIG. 11.

In some aspects of the disclosure, the processor 1204 may include communication circuitry 1240 configured (e.g., in coordination with the memory 1205 and the transceiver 1210) for various functions, including, for example, transmitting and/or receiving data, control signaling, and reference signals over a wireless air interface. The processor 1204 may further include channel characterization circuitry 1242 configured (e.g., in coordination with the memory 1205 and the transceiver 1210) for various functions, including, for example, receiving and performing suitable measurements on a signal such as a reference signal.

And further, the computer-readable storage medium 1206 may store computer-executable code that includes communication instructions 1260 that configure a scheduled entity 1200 configured (e.g., in coordination with the memory 1205 and the transceiver 1210) for various functions, including, for example, transmitting and/or receiving data, control signaling, and reference signals over a wireless air interface. The computer-readable storage medium 1206 may further store computer-executable code that includes channel characterization instructions 1262 that configure a scheduled entity 1200 configured (e.g., in coordination with the memory 1205 and the transceiver 1210) for various functions, including, for example, receiving and performing suitable measurements on a signal such as a reference signal.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1, 2, and/or 4, and utilizing, for example, the processes and/or algorithms described herein in relation to FIGS. 8A, 9A, and 10A.

### FURTHER EXAMPLES HAVING A VARIETY OF FEATURES

Example 1: A method, apparatus, and non-transitory computer-readable medium for generating a channel estimate. A reference signal is received by a user equipment (UE) from a base station over a plurality of ports. The UE measures amplitudes of the reference signal over a first plurality of frequency domain (FD) basis components of a first port in the plurality of ports. A first amplitude of the reference signal over a first FD basis component of the first plurality of FD basis components is multiplied by a second amplitude of the reference signal over a second FD basis component of the first plurality of FD basis components by the UE to generate a modified amplitude. The UE associates the modified amplitude with the second FD basis component in a channel state report and transmits the channel state report to the base station.

Example 2: A method, apparatus, and non-transitory computer-readable medium for generating a channel estimate of Example 1, including determining, by the UE, that the first amplitude is a highest amplitude of all amplitudes associated with the FD basis components of the first port and associating, by the user equipment, a normalized amplitude value of 1 with the first FB basis component of the first port in the channel state report.

Example 3: A method, apparatus, and non-transitory computer-readable medium for generating a channel estimate of Examples 1 to 2, where the UE quantizes the modified amplitude before incorporating the modified amplitude into the channel state report.

Example 4: A method, apparatus, and non-transitory computer-readable medium for generating a channel estimate of Examples 1 to 3, where the UE measures phase offsets of the reference signal over the first plurality of frequency division (FD) basis components of the first port in the plurality of ports and normalizes a second phase offset of the second FD basis component by dividing the second phase offset of the second FD basis component by a first phase offset of the first FD basis component.

Example 5: A method, apparatus, and non-transitory computer-readable medium for generating a channel estimate of Examples 1 to 4, where the UE measures amplitudes of the reference signal over a second plurality of FD basis components of a second port in the plurality of ports, multiplies a third amplitude of the reference signal over a third FD basis component of the second plurality of FD basis components by a fourth amplitude of the reference signal over a fourth FD basis component of the plurality of FD basis components to generate a second modified amplitude, and associates the second modified amplitude with the fourth FD basis component in the channel state report.

Example 6: A method, apparatus, and computer-readable medium for generating a channel estimate. A reference signal is received from a base station over a plurality of ports. A UE measures amplitudes of the reference signal over a plurality of ports and determines a first subgroup of the plurality of ports and a second subgroup of the plurality of ports. The UE determines a first amplitude of the reference signal for a first port in the first subgroup that is a highest amplitude of all amplitudes for ports of the plurality of ports in the first subgroup and associates a normalized amplitude value with the first port in a channel state report.

Example 7: A method, apparatus, and non-transitory computer-readable medium for generating a channel estimate of Example 6, where the UE determines a second amplitude of the reference signal for a second port in the second subgroup that is a highest amplitude of all amplitudes of ports in the second subgroup, multiplies the second amplitude by a third amplitude of the reference signal for a third port in the second subgroup to generate a modified amplitude, and associates the modified amplitude with the third port of the second subgroup in the channel state report.

Example 8. A method, apparatus, and non-transitory computer-readable medium for generating a channel estimate of Examples 6 to 7, wherein the UE receives an identification of the first subgroup of the plurality of ports and the second subgroup of the plurality of ports from a base station.

Example 9. A method, apparatus, and non-transitory computer-readable medium for generating a channel estimate of Examples 6 to 8, where the UE quantizes the modified amplitude before associating the modified amplitude with the third port of the second subgroup in the channel state report.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for generating a channel estimate, the method comprising:
receiving, by a user equipment and from a base station, a reference signal over a plurality of ports;
measuring, by the user equipment, amplitudes of the reference signal over a first plurality of frequency domain (FD) basis components of a first port in the plurality of ports;
multiplying, by the user equipment, a first amplitude of the reference signal over a first FD basis component of the first plurality of FD basis components by a second amplitude of the reference signal over a second FD basis component of the first plurality of FD basis components to generate a modified amplitude;
associating, by the user equipment, the modified amplitude with the second FD basis component in a channel state report; and
transmitting, by the user equipment and to the base station, the channel state report.

2. The method of claim 1, further comprising:
determining, by the user equipment, that the first amplitude is a highest amplitude of all amplitudes associated with the FD basis components of the first port; and
associating, by the user equipment, a normalized amplitude value of 1 with the first FB basis component of the first port in the channel state report.

3. The method of claim 1, further comprising quantizing the modified amplitude before incorporating the modified amplitude into the channel state report.

4. The method of claim 1, further comprising the steps of:
measuring, by the user equipment, phase offsets of the reference signal over the first plurality of frequency division (FD) basis components of the first port in the plurality of ports; and
normalizing a second phase offset of the second FD basis component by dividing the second phase offset of the second FD basis component by a first phase offset of the first FD basis component.

5. The method of claim 1, further comprising the steps of:
measuring, by the user equipment, amplitudes of the reference signal over a second plurality of FD basis components of a second port in the plurality of ports;
multiplying, by the user equipment, a third amplitude of the reference signal over a third FD basis component of the second plurality of FD basis components by a fourth amplitude of the reference signal over a fourth FD basis component of the plurality of FD basis components to generate a second modified amplitude; and
associating, by the user equipment, the second modified amplitude with the fourth FD basis component in the channel state report.

6-9. (canceled)

10. An apparatus for wireless communication, comprising:
mean for receiving, by a user equipment and from a base station, a reference signal over a plurality of ports;
mean for measuring, by the user equipment, amplitudes of the reference signal over a first plurality of frequency domain (FD) basis components of a first port in the plurality of ports;
mean for multiplying, by the user equipment, a first amplitude of the reference signal over a first FD basis component of the first plurality of FD basis components by a second amplitude of the reference signal over a second FD basis component of the first plurality of FD basis components to generate a modified amplitude;
mean for associating, by the user equipment, the modified amplitude with the second FD basis component in a channel state report; and
mean for transmitting, by the user equipment and to the base station, the channel state report.

11. The apparatus of claim 10, further comprising:
mean for determining, by the user equipment, that the first amplitude is a highest amplitude of all amplitudes associated with the FD basis components of the first port; and
mean for associating, by the user equipment, a normalized amplitude value of 1 with the first FB basis component of the first port in the channel state report.

12. The apparatus of claim 10, further comprising mean for quantizing the modified amplitude before incorporating the modified amplitude into the channel state report.

13. The apparatus of claim 10, further comprising:
mean for measuring, by the user equipment, phase offsets of the reference signal over the first plurality of frequency division (FD) basis components of the first port in the plurality of ports; and
mean for normalizing a second phase offset of the second FD basis component by dividing the second phase offset of the second FD basis component by a first phase offset of the first FD basis component.

14. The apparatus of claim 10, further comprising:
mean for measuring, by the user equipment, amplitudes of the reference signal over a second plurality of FD basis components of a second port in the plurality of ports;
mean for multiplying, by the user equipment, a third amplitude of the reference signal over a third FD basis component of the second plurality of FD basis components by a fourth amplitude of the reference signal over a fourth FD basis component of the plurality of FD basis components to generate a second modified amplitude; and
mean for associating, by the user equipment, the second modified amplitude with the fourth FD basis component in the channel state report.

15-18. (canceled)

19. A non-transitory computer-readable medium storing computer-executable code, comprising code for causing a user equipment to:
receive, from a base station, a reference signal over a plurality of ports;
measure amplitudes of the reference signal over a first plurality of frequency domain (FD) basis components of a first port in the plurality of ports;
multiply a first amplitude of the reference signal over a first FD basis component of the first plurality of FD basis components by a second amplitude of the reference signal over a second FD basis component of the first plurality of FD basis components to generate a modified amplitude;
associate the modified amplitude with the second FD basis component in a channel state report; and
transmit, to the base station, the channel state report.

20. The non-transitory computer-readable medium of claim 19, wherein the code is further for causing the user equipment to:
determine that the first amplitude is a highest amplitude of all amplitudes associated with the FD basis components of the first port; and
associate a normalized amplitude value of 1 with the first FB basis component of the first port in the channel state report.

21. The non-transitory computer-readable medium of claim 19, wherein the code is further for causing the user equipment to quantize the modified amplitude before incorporating the modified amplitude into the channel state report.

22. The non-transitory computer-readable medium of claim 19, wherein the code is further for causing the user equipment to:
measure phase offsets of the reference signal over the first plurality of frequency division (FD) basis components of the first port in the plurality of ports; and
normalize a second phase offset of the second FD basis component by dividing the second phase offset of the second FD basis component by a first phase offset of the first FD basis component.

23. The non-transitory computer-readable medium of claim 19, wherein the code is further for causing the user equipment to:
measure amplitudes of the reference signal over a second plurality of FD basis components of a second port in the plurality of ports;
multiply a third amplitude of the reference signal over a third FD basis component of the second plurality of FD basis components by a fourth amplitude of the reference signal over a fourth FD basis component of the plurality of FD basis components to generate a second modified amplitude; and
associate the second modified amplitude with the fourth FD basis component in the channel state report.

24-27. (canceled)

28. An apparatus for wireless communication, comprising:
a processor;
a transceiver communicatively coupled to the at least one processor; and
a memory communicatively coupled to the at least one processor,
wherein the processor is configured to:
receive, from a base station, a reference signal over a plurality of ports;
measure amplitudes of the reference signal over a first plurality of frequency domain (FD) basis components of a first port in the plurality of ports;
multiply a first amplitude of the reference signal over a first FD basis component of the first plurality of FD basis components by a second amplitude of the reference signal over a second FD basis component of the first plurality of FD basis components to generate a modified amplitude;
associate the modified amplitude with the second FD basis component in a channel state report; and
transmit, to the base station, the channel state report.

29. The apparatus of claim 28, wherein the processor and the memory are further configured to:
determine that the first amplitude is a highest amplitude of all amplitudes associated with the FD basis components of the first port; and
associate a normalized amplitude value of 1 with the first FB basis component of the first port in the channel state report.

30. The apparatus of claim 28, wherein the processor and the memory are further configured to quantize the modified amplitude before incorporating the modified amplitude into the channel state report.

31. The apparatus of claim 28, wherein the processor and the memory are further configured to:
measure phase offsets of the reference signal over the first plurality of frequency division (FD) basis components of the first port in the plurality of ports; and
normalize a second phase offset of the second FD basis component by dividing the second phase offset of the second FD basis component by a first phase offset of the first FD basis component.

32. The apparatus of claim 28, wherein the processor and the memory are further configured to:
measure amplitudes of the reference signal over a second plurality of FD basis components of a second port in the plurality of ports;
multiply a third amplitude of the reference signal over a third FD basis component of the second plurality of FD basis components by a fourth amplitude of the reference signal over a fourth FD basis component of the plurality of FD basis components to generate a second modified amplitude; and
associate the second modified amplitude with the fourth FD basis component in the channel state report.

33-37. (canceled)
